(19) United States
(12) Patent Application Publication
(10) Pub. No.: US 2008/0273472 A1
(43) Pub. Date: Nov. 6, 2008

(54) ETHERNET RESOURCE MANAGEMENT

(76) Inventors: ADRIAN BASHFORD, Ottawa (CA); GERALD SMALLEGANGE, Stittsville (CA); DONALD ELLIS, Ottawa (CA); DALE ZACHARIAS, Ottawa (CA)

Correspondence Address: RIDOUT & MAYBEE LLP, 225 KING STREET WEST, 10TH FLOOR, TORONTO, ON, M5V 3M2, CA

(21) Appl. No.: 11/963,172

(22) Filed: Dec. 21, 2007

Related U.S. Application Data
(60) Provisional application No. 60/915,736, filed on May 3, 2007.

(51) Int. Cl. H04L 12/28

(52) U.S. Cl. 370/254

(57) ABSTRACT

The state of resources (e.g., links, trunks, services) of an Ethernet Resource may be maintained at a management console. Upon detection of a change of state in a given resource, a management agent of a node in the Ethernet Resource may indicate the state change to the management console in a MIB. Upon receipt of the indication of change, the management console can update a record of the state of the given resource.

### CROSS-REFERENCE TO RELATED APPLICATIONS

The present application claims priority to U.S. Provisional Patent Application Ser. No. 60/915,736, filed May 3, 2007, the contents of which are hereby incorporated herein by reference.

### FIELD OF THE INVENTION

The present application relates generally to Ethernet networks and, more specifically, to the management of Ethernet networks.

### BACKGROUND OF THE INVENTION

Today, in circuit based networks, the operational model for digital network resources allows for an In-Service or an Out-of-Service maintenance state for the administration of nodes, connections, links, paths and service layer. Similarly, the operational model for Synchronous Optical Networking (SONET), Synchronous Digital Hierarchy (SDH) and Asynchronous Transfer Mode (ATM) network resources allows for an In-Service or an Out-of-Service maintenance state for the administration of nodes, connections, links, paths and service layer.

Legacy SONET/SDH networks are currently being replaced by Multi Protocol Label Switching (MPLS) networks and networks based on Provider Backbone Bridges (PBB) and Provider Backbone Transport (PBT) technologies. In MPLS or PBB/PBT networks, concepts of Operation, Administration and Maintenance (OAM) exist, but are lacking in various key areas when compared to legacy SONET, SDH and ATM networks. A few examples of these key areas are the concept of a “partially failed entity”, enhanced maintenance states and a general lack of a consistent state machine and state transitions across all applications (single resource, many resource, protection switching, etc.). For example, a fairly good management information base (MIB) is defined for an Ethernet interface, but a consistent one does not exist for Virtual Local Area Networks (VLANs).

As networks having a circuit-based infrastructure are replaced with networks having a packet-based infrastructure, it has been recognized that some benefits may be gained from using an Ethernet-based (Layer 2 and Layer 1) solution in place of an Internet Protocol (IP) and MPLS (Layer 3 and Layer 2) solution. The Ethernet-based solution, given a specific methodology, can allow replacement of the circuit-based infrastructure network with a packet-based infrastructure having specific OAM features.

The current Ethernet-based LAN solutions define Ethernet as “always on” and have no real operational states. In the current methodology, a LAN is defined as a full shared resource that is either “working” or “failed”. Additionally, LANs currently do not support specific Layer 2 services correlated to specific LANs.

The LAN does support IP services and applications, but the IP services are dynamic flows that originate and terminate without a given operational state. This methodology of state management is in conflict with traditional IP network architectures. However, if packet technology is to replace the basic infrastructure networks, then many infrastructure providers want and need to account for each resource in order to offer predictable networks and services. When resources are assigned, as a service, a connection or a link, to a given user, the administrator needs to assure the user that the appropriate Ethernet resources are available and may be required to report on resources used for each Ethernet resource. In a LAN with a packet-based infrastructure, there is a common resource that is fully shared and specific Ethernet resource reports are not required.

For packet Metro Area Network (MAN) applications, there may be a common network, but the Provider may need both network records (internal accounting) and service records (Service Level Agreement reporting) for each user or client.

IP networks can also offer logical states, but the current industry trend is towards dynamic allocation of resources and there seems little interest in management of network or service resources. IP/MPLS networks have started to address a small amount of service management via the pseudo wire (PW) solutions, but the only methods seem to include working and fault states, with minimum service features as part of any structured MIB.

Clearly, packet-based infrastructure networks may be improved by adding OAM features and functions familiar from circuit-based infrastructure networks.

### SUMMARY

The state of resources (e.g., links, trunks, services) of an Ethernet Resource may be maintained at a management console. Upon detection of a change of state in a given resource, a management agent of a node in the Ethernet Resource may indicate the state change to the management console in a MIB. Upon receipt of the indication of change, the management console can update a record of the state of the given resource.

In accordance with an aspect of the present invention there is provided a method of maintaining a record of a state of a resource within an Ethernet Resource, the Ethernet Resource including a plurality of nodes connected by a plurality of links. The method includes receiving a message from a given node among the plurality of nodes and, based on the content, updating the record of the state of the resource to a new state. The content includes a reference to a given resource, an indication of an administrative state of the given resource, where the administrative state is selected from an administrative up state and an administrative down state and an indication of an operational state of the given resource, where the operational state is selected from an operational up state, an operational degraded state and an operational down state. In other aspects of the present invention, a system is provided for carrying out this method and a computer readable medium is provided for adapting an apparatus to carry out this method.

In accordance with another aspect of the present invention there is provided a method of facilitating management of a state of a resource within an Ethernet Resource, the Ethernet Resource including a plurality of nodes connected by a plurality of links. The method including detecting a change in state of a given resource and transmitting a message to a management system, the message identifying the given resource, an operational state of the given resource and an administrative state of the resource. In other aspects of the present invention, a node is provided for carrying out this method and a computer readable medium is provided for adapting an apparatus to carry out this method.

In accordance with a further aspect of the present invention there is provided a computer readable medium storing a Management Information Base (MIB) to support an Operation, Administration and Maintenance structure for an Ethernet Resource. The MIB includes a reference to a given resource, an indication of an administrative state of the given resource, where the administrative state is selected from an administrative up state and an administrative down state and an indication of an operational state of the given resource, where the operational state is selected from an operational up state, an operational degraded state and an operational down state.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Reference will now be made to the drawings, which show by way of example, embodiments of the invention, and in which:

FIG. 1 illustrates a block diagram of a system in which aspects of the present invention may be employed, the system including a Ethernet Resource having nodes with management agents, the system also including a data communications network and various systems with associated management consoles;

FIG. 2A illustrates the Ethernet Resource of FIG. 1 with additional detail;

FIG. 2B illustrates simplified views of various resources in FIG. 2A;

FIG. 3 illustrates example steps in a method allowing a management agent of FIG. 1 to facilitate management of a state of the resources within the Ethernet Resource of FIG. 1;

FIG. 4 illustrates example steps in a method allowing a management console of FIG. 1 to manage states of resources within the Ethernet Resource of FIG. 1;

FIG. 5 illustrates a state machine for the Ethernet Resource of FIG. 2A;

FIG. 6 illustrates a table comparing states for a variety of protocols.

### DETAILED DESCRIPTION OF THE EMBODIMENTS

Aspects of the present invention enable exploiting existing and emerging Ethernet resources and defining of Ethernet states, movement between states and the various management information bases (MIBs) for defining emerging Ethernet packet switched network solutions. Various states for Ethernet may be defined at the node layer, the connection (trunk/domain) layer, the link layer, the path layer and the service layer. Each layer can share a common structure to define state and will have common objects that can be associated with both logical and physical resources.

Disclosed methods allow operators to better understand and allocate resources and define the operational state of each resource. The structure and method allows operational consistency at the link, node, network and service layer of a packet infrastructure network.

The specific solution is to utilize Media Access Control (MAC) port addressing and exploit the latest standards. These solutions, when coupled with specific networking solutions, allow tracing, tracking and trouble shooting features for access and metro packet networks. The PBB/PBT solution will allow equivalent features and functions as today's existing circuit solutions.

The standards referenced above include a number of existing and new standards including those specified by the Institute for Electrical and Electronics Engineers (IEEE) and referred to as 802.1pQ, 802.1ad, 802.1ah, 802.1aq and 802.1ag. The standards also include the Y.1731 recommendation established by the Telecommunication branch of the International Telecommunications Union (ITU-T).

The 802.1ag standard is being formalized by the IEEE to provide a mechanism for Service Layer OAM (Connectivity Fault Management). This allows discovery and verification of a path through 802.1 bridges and LANs. The 802.1ag standard also takes care of:
defining Maintenance Domains, the Maintenance Points constituting the Maintenance Domains, and the managed objects required to create and administer them;
defining the relationship between Maintenance Domains and the services offered by VLAN-aware Bridges and the services offered by Provider Bridges;
describing the protocols and procedures used by Maintenance Points to maintain and diagnose connectivity faults within a Maintenance Domain; and
providing means for future expansion of the capabilities of Maintenance Points and their protocols.

IEEE 802.1ag Ethernet Connectivity Fault Management (CFM) Protocols include three protocols that work together to help administrators debug Ethernet networks. The three protocols are known as: a continuity check protocol, a link trace protocol and a loopback protocol.

The 802.1ah standard established by the IEEE is known as Provider Backbone Bridges (PBB) and also as Mac-in-Mac or M-in-M. PBB is available in carrier layer 2 Ethernet switches today and it allows for layering the Ethernet network into customer and provider domains with complete isolation among their MAC addresses. It defines a B-DA and B-SA to indicate the backbone source and destination address. It also define B-VID (backbone VLAN ID)and I-SID (Service Instance VLAN ID).

Creation of the Ethernet Service ID, the Ethernet MAC/VLAN packet trunk and the association of physical and logical resources as defined in IEEE 802.1ad/ah/ag offer new management options.

Amendments to the IEEE 802.1Q standard establish parameters for backbone packet-based bridging networks. Examples of the amendments are known as IEEE 802.1ad and IEEE 802.1ah. Management of a large scale service provider network may be geographically divided to allow for a regional approach to managing the physical infrastructure. In contrast, management of the services being deployed on the service provider network may not be divided as easily.

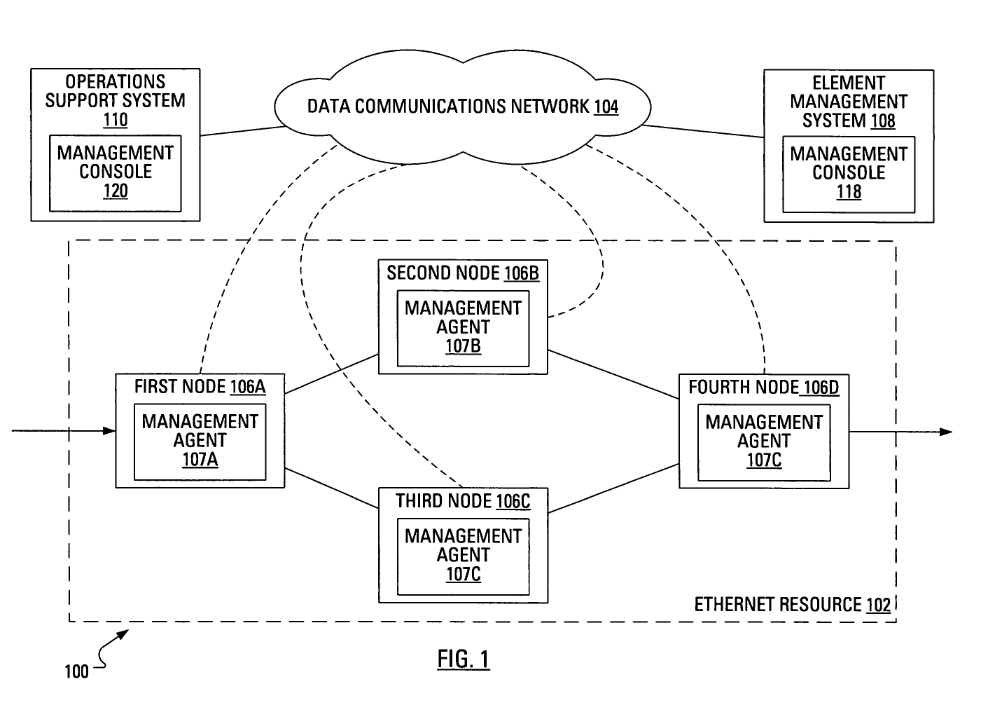

Referring now to FIG. 1, a block diagram of a system 100 is illustrated. The system 100 includes an Ethernet Resource 102. The Ethernet Resource 102, as illustrated, includes a first node 106A, a second node 106B, a third node 106C and a fourth Node 106D (collectively or individually 106). The nodes 106 of the Ethernet Resource 102 are connected to each other and to a data communication network 104. Through the data communication network 104, the nodes 106 may communicate with a resource management system (EMS) 108 and an Operations Support System (OSS) 110.

The first node 106A includes a first management agent 107A. The second node 106B includes a second management agent 107B. The third node 106C includes a third management agent 107C. The fourth node 106D includes a fourth management agent 107D. The management agents may be collectively or individually referred to by the reference numeral 107. The EMS 108 includes a management console 118 that receives transmissions from the management agents 107 and, thereby, maintains an administrative and operational status of the Ethernet Resource 102. Similarly, a management console 120 at the OSS 110 may also receive transmissions from the management agents 107 and, thereby, maintain an administrative and operational status of the Ethernet Resource 102.

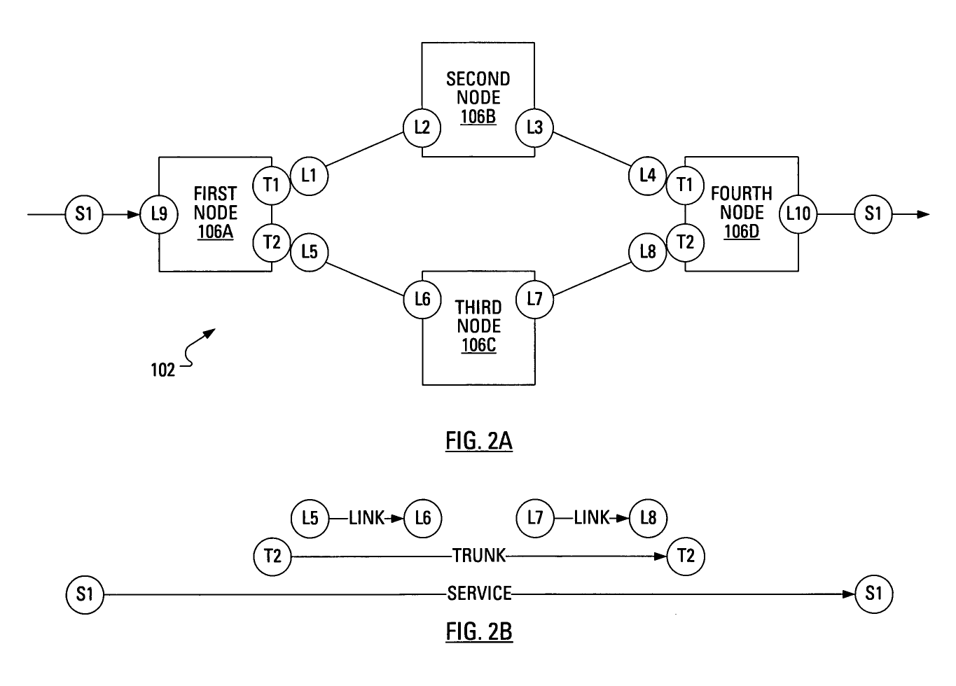

FIG. 2A illustrates, schematically, the Ethernet Resource 102 with additional detail provided for the nodes 106. A generic Ethernet Resource can be considered to provide a “service”. As is used herein, the term “service” applies to end-to-end connectivity being offered to users of the Ethernet Resource 102. Within the Ethernet Resource 102, trunks may be used to carry traffic related to end-to-end connectivity in whole or in part. It should be understood that connectivity can be point-to-point, multi-point and point-to-multi-point.

In FIG. 2A, the end points of the service provided by the Ethernet Resource 102 are labeled “S1”. This point is emphasized in FIG. 2B wherein the service resource of the Ethernet Resource 102 is illustrated as a single connector between end points labeled “S1”.

Two trunks are available to the service. End points of a first trunk are labeled “T1”. End points of a second trunk are labeled “T2”. This point is emphasized in FIG. 2B wherein the second trunk resource of the Ethernet Resource 102 is illustrated as a single connector between end points labeled “T2”.

Each of the trunks is made up of links between nodes 106. Each of the links has an end point on two of the nodes 106. End points of a first link are labeled “L1”, on the first node 106A, and “L2”, on the second node 106B. End points of a second link are labeled “L3”, on the second node 106B, and “L4”, on the fourth node 106D. End points of a third link are labeled “L5”, on the first node 106A, and “L6”, on the third node 106C. End points of a fourth link are labeled “L7”, on the third node 106C, and “L8”, on the fourth node 106D. An end point on the ingress end of the service is labeled “L9” on the first node 106A. An end point on the egress end of the service is labeled “L10” on the fourth node 106D. The foregoing is emphasized in FIG. 2B wherein the two link resources of the second trunk resource of the Ethernet Resource 102 are illustrated as the third link between end points labeled “L5” and “L6” and the fourth link between end point labeled “L7” and “L8”.

The state of a given resource (i.e., link, trunk or service) of the Ethernet Resource 102 can be detected, by a given node 106 that includes a related end point, through the use of various mechanisms specified in the IEEE 802.1ag standard and the ITU-T Y.1731 recommendation. For instance, the node 106 can issue Continuity Check frames periodically. A timely response to a Continuity Check frame indicates an operational link, trunk or service.

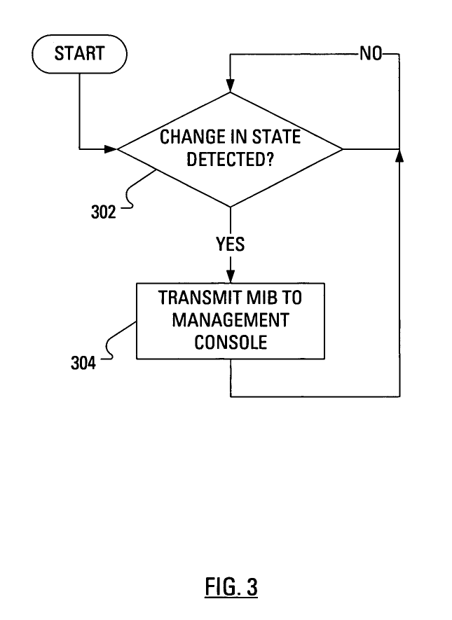

In view of FIG. 3, the management agent 107 of the given node 106 may determine (step 302) whether a change in state has been detected for a resource associated with the given node 106.

Upon detecting no change, the management agent 107 continues to await a state change.

Upon detecting a change, the management agent 107 transmits (step 304) a message including an indication of the new state of the resource to one or more management consoles, e.g., the management console 118 at the EMS 108. The message may include a Management Information Base (MIB). The following proposed MIB defines a structure for organizing a report of the state of the resource. MIBs are known in various networking contexts, in particular, MIBs are used in the context of the known Simple Network Management Protocol (SNMP).

A proposed MIB for facilitating management of an Ethernet Resource:

-- The Ethernet Resources table
-- The Ethernet Resources table contains information related to Ethernet
-- Resource endpoints configured against an interface. An Ethernet Resource
-- index can represent a VLAN or any other identifier that represents a
-- Ethernet Resource endpoint on an interface.
ethResTable OBJECT-TYPE

| | |
|---|---|
| SYNTAX | SEQUENCE OF IfEntry |
| MAX-ACCESS | not-accessible |
| STATUS | current |
| DESCRIPTION | |

“A list of ethRes entries. The number of entries is given by
the value of ethResIndex and ifIndex.”

::= { ethRess 1 }
ethResEntry OBJECT-TYPE

| | |
|---|---|
| SYNTAX | ethResEntry |
| MAX-ACCESS | not-accessible |
| STATUS | current |
| DESCRIPTION | |

| | “An entry containing management information applicable to a |
|---|---|
| | particular ethRes on a specific interface.” |
| INDEX | { ifIndex, ethResIndex} |

```
    ::= { ethResTable 1 }
ethResEntry ::=
    SEQUENCE {
```

| | |
|---|---|
| ifIndex | InterfaceIndex, |
| ethResIndex | EthResIndex, |
| ethResType | INTEGER, |
| ethResDescr | DisplayString, |
| ethResMtu | Integer32, |
| ethResAdminStatus | INTEGER, |
| ethResOperStatus | INTEGER, |
| ethResUpDownTrapEnable | INTEGER, |
| ethResBandwidthProfileId | INTEGER, |
| ethResLastChange | TimeTicks, |

}
ifIndex OBJECT-TYPE

| | |
|---|---|
| SYNTAX | InterfaceIndex |
| MAX-ACCESS | read-only |
| STATUS | current |
| DESCRIPTION | |

“A unique value, greater than zero, for each interface. It is
recommended that values are assigned contiguously starting from
1. The value for each interface must remain constant at least
from one re-initialization of the entity's network management
system to the next re-initialization.”

::= { ethResEntry 1 }
ethResIndex OBJECT-TYPE

| | |
|---|---|
| SYNTAX | EthResIndex |
| MAX-ACCESS | read-only |
| STATUS | current |
| DESCRIPTION | |

“A unique value, greater than zero, that represents a Service
or Trunk. An ethResIndex can be a VLAN or any other identifier
that refers to a service or trunk. If the value is zero it
indicates a service or trunk is not present and the MIB is
addressing the interface.”

::= { ethResEntry 2 }
ethResType OBJECT-TYPE

| | |
|---|---|
| SYNTAX | NTEGER { |
| | Link(0), |
| | Service(1), |
| | Trunk(2) |
| | } |

| | |
|---|---|
| MAX-ACCESS | read-only |
| STATUS | current |
| DESCRIPTION | |

“Identifies the ethResIndex as a Link(0), a Service(1) or a
Trunk(2).”

::= { ethResEntry 3 }
ethResDescr OBJECT-TYPE

| | |
|---|---|
| SYNTAX | DisplayString (SIZE (0..255)) |
| MAX-ACCESS | read-only |
| STATUS | current |
| DESCRIPTION | |

“A textual string containing information about the ethRes.
This string can include the name and location of a customer.”

::= { ethResEntry 4 }
ethResMtu OBJECT-TYPE

| | |
|---|---|
| SYNTAX | Integer32 |
| MAX-ACCESS | read-only |
| STATUS | current |
| DESCRIPTION | |

“The size of the largest packet which can be sent/received on
the interface, specified in octets. For interfaces that are
used for transmitting network datagrams, this is the size of
the largest network datagram that can be sent on the
interface.”

::= { ethResEntry 5 }
ethResAdminStatus OBJECT-TYPE

| SYNTAX | INTEGER { | |
|---|---|---|
| | up(1), | -- ready to pass packets |
| | down(2), | |
| | testing(3) | -- in some test mode |
| | } | |

| | |
|---|---|
| MAX-ACCESS | read-write |
| STATUS | current |
| DESCRIPTION | |

“The desired state of the ethRes on a specific interface. The
testing(3) state indicates that no operational packets can be
passed. When a managed system initializes, all ethRes endpoints
start with ethResAdminStatus in the down(2) state. As a result
of either explicit management action or per configuration
information retained by the managed system, ethResAdminStatus
is then changed to either the up(1) or testing(3) states (or
remains in the down(2) state).”

::= { ethResEntry 6 }
ethResOperStatus OBJECT-TYPE

| SYNTAX | INTEGER { | |
|---|---|---|
| | up(1), | -- ready to pass packets |
| | down(2), | |
| | testing(3), | -- in some test mode |
| | unknown(4), | -- status can not be determined |
| | | -- for some reason. |
| | dormant(5), | |
| | notPresent(6), | -- some component is missing |
| | lowerLayerDown(7) | -- down due to state of |
| | | -- lower-layer interface(s) |
| | degraded(8) | -- unable to provide full service |
| | } | |

| | |
|---|---|
| MAX-ACCESS | read-only |
| STATUS | current |
| DESCRIPTION | |

“The current operational state of the Ethernet resource
endpoint. Meaning of Some states is different than defined in
the ifMIB. The ethResOperStatus are determined based on the
ability of the Ethernet Resources to provide service
independent of the ethResAdminStatus.
Up(1) state indicates no failures the resource is fully capable
of providing service.
Down(2) indicates the resource is failed and not capable of
providing service.
Testing(3) indicates that no operational packets can be passed.
Unknown(4) indicates the status can not be determined.
Degraded(8) indicates the resource is partially able to support
service, it may be partially failed or otherwise degraded.”

::= { ethResEntry 7 }
ethResUpDownTrapEnable OBJECT-TYPE

| | |
|---|---|
| SYNTAX | INTEGER { enabled(1), disabled(2) } |
| MAX-ACCESS | read-write |
| STATUS | current |
| DESCRIPTION | |

“Indicates whether traps should be generated for this Ethernet
resource endpoint for Admin or Operational status changes. By
default, this object should have the value disabled(2).”

::= { ethResEntry 8 }
ethResBandwidthProfileId OBJECT-TYPE

| | |
|---|---|
| SYNTAX | INTEGER {0..255} |
| MAX-ACCESS | read-write |
| STATUS | current |
| DESCRIPTION | |

“Provides the index of the bandwidth profile used to police
this EthRes endpoint.”

::= { ethResEntry 9 }
ethResLastChange OBJECT-TYPE

| | |
|---|---|
| SYNTAX | TimeTicks |
| MAX-ACCESS | read-only |
| STATUS | current |
| DESCRIPTION | |

“The value of sysUpTime at the time the interface entered its
current operational state. If the current state was entered
prior to the last re-initialization of the local network
management subsystem, then this object contains a zero value.”

::= { ethResEntry 10 }
ethResCOSTable OBJECT-TYPE

| | |
|---|---|
| SYNTAX | SEQUENCE OF EthResEntry |
| MAX-ACCESS | not-accessible |
| STATUS | current |
| DESCRIPTION | |

“A list of interface entries. The number of entries is given
by the value of ethResNumber.”

::= { interfaces 2 }
ethResCOSEntry OBJECT-TYPE

| | |
|---|---|
| SYNTAX | EthResEntry |
| MAX-ACCESS | not-accessible |
| STATUS | current |
| DESCRIPTION | |

| | “An entry containing management information applicable to a |
|---|---|
| | particular interface.” |
| INDEX | { ifIndex, ethResIndex, COSIndex } |

```
    ::= { ethResCOSTable 1 }
EthResCOSEntry ::=
    SEQUENCE {
```

| | |
|---|---|
| ifIndex | InterfaceIndex, |
| ethResIndex | ethResIndex, |
| classOfEthResIndex | INTEGER, |
| ethResCOSInFrames | Counter64, |
| ethResCOSInFramesConforming | Counter64, |
| ethResCOSInFramesNonConforming | Counter64, |
| ethResCOSInFramesUnicast | Counter64, |
| ethResCOSInFramesUnicastConforming | Counter64, |
| ethResCOSInFramesUnicastNonConforming | Counter64, |
| ethResCOSInFramesMulticast | Counter64, |
| ethResCOSInFramesMulticastConforming | Counter64, |
| ethResCOSInFramesMulticastNonConforming | Counter64, |
| ethResCOSInFramesBroadcast | Counter64, |
| ethResCOSInFramesBroadcastConforming | Counter64, |
| ethResCOSInFramesBroadcastNonConforming | Counter64 |
| ethResCOSOutFrames | Counter64, |
| ethResCOSOutFramesConforming | Counter64, |
| ethResCOSOutFramesNonConforming | Counter64, |
| ethResCOSOutFramesUnicast | Counter64, |
| ethResCOSOutFramesUnicastConforming | Counter64, |
| ethResCOSOutFramesUnicastNonConforming | Counter64, |
| ethResCOSOutFramesMulticast | Counter64, |
| ethResCOSOutFramesMulticastConforming | Counter64, |
| ethResCOSOutFramesMulticastNonConforming | Counter64, |
| ethResCOSOutFramesBroadcast | Counter64, |
| ethResCOSOutFramesBroadcastConforming | Counter64, |
| ethResCOSOutFramesBroadcastNonConforming | Counter64, |

| | |
|---|---|
| ethResCOSInDiscardsFramesGrosslyNonConforming | Counter64, |
| ethResCOSInDiscardsFramesUnicastGrosslyNonConforming | Counter64, |
| ethResCOSInDiscardsFramesMulticastGrosslyNonConforming | Counter64, |
| ethResCOSInDiscardsFramesBroadcastGrosslyNonConforming | Counter64, |

| | |
|---|---|
| ethResCOSOutDiscardsFrames | Counter64, |
| ethResCOSOutDiscardsFramesConforming | Counter64, |
| ethResCOSOutDiscardsFramesNonConforming | Counter64, |
| ethResCOSOutDiscardsFramesUnicast | Counter64, |
| ethResCOSOutDiscardsFramesUnicastConforming | Counter64, |
| ethResCOSOutDiscardsFramesUnicastNonConforming | Counter64, |
| ethResCOSOutDiscardsFramesMulticast | Counter64, |
| ethResCOSOutDiscardsFramesMulticastConforming | Counter64, |
| ethResCOSOutDiscardsFramesMulticastNonConforming | Counter64, |
| ethResCOSOutDiscardsFramesBroadcast | Counter64, |
| ethResCOSOutDiscardsFramesBroadcastConforming | Counter64, |
| ethResCOSOutDiscardsFramesBroadcastNonConforming | Counter64, |

| | |
|---|---|
| ethResCOSInOctets | Counter64, |
| ethResCOSInOctetsConforming | Counter64, |
| ethResCOSInOctetsNonConforming | Counter64, |
| ethResCOSInOctetsUnicast | Counter64, |
| ethResCOSInOctetsUnicastConforming | Counter64, |
| ethResCOSInOctetsUnicastNonConforming | Counter64, |
| ethResCOSInOctetsMulticast | Counter64, |
| ethResCOSInOctetsMulticastConforming | Counter64, |
| ethResCOSInOctetsMulticastNonConforming | Counter64, |
| ethResCOSInOctetsBroadcast | Counter64, |
| ethResCOSInOctetsBroadcastConforming | Counter64, |
| ethResCOSInOctetsBroadcastNonConforming | Counter64, |
| ethResCOSOutOctets | Counter64, |
| ethResCOSOutOctetsConforming | Counter64, |
| ethResCOSOutOctetsNonConforming | Counter64, |
| ethResCOSOutOctetsUnicast | Counter64, |
| ethResCOSOutOctetsUnicastConforming | Counter64, |
| ethResCOSOutOctetsUnicastNonConforming | Counter64, |
| ethResCOSOutOctetsMulticast | Counter64, |
| ethResCOSOutOctetsMulticastConforming | Counter64, |
| ethResCOSOutOctetsMulticastNonConforming | Counter64, |
| ethResCOSOutOctetsBroadcast | Counter64, |
| ethResCOSOutOctetsBroadcastConforming | Counter64, |
| ethResCOSOutOctetsBroadcastNonConforming | Counter64, |

| | |
|---|---|
| ethResCOSInDiscardsOctetsGrosslyNonConforming | Counter64, |
| ethResCOSInDiscardsOctetsUnicastGrosslyNonConforming | Counter64, |
| ethResCOSInDiscardsOctetsMulticastGrosslyNonConforming | Counter64, |
| ethResCOSInDiscardsOctetsBroadcastGrosslyNonConforming | Counter64, |

| | |
|---|---|
| ethResCOSOutDiscardsOctets | Counter64, |
| ethResCOSOutDiscardsOctetsConforming | Counter64, |
| ethResCOSOutDiscardsOctetsNonConforming | Counter64, |
| ethResCOSOutDiscardsOctetsUnicast | Counter64, |
| ethResCOSOutDiscardsOctetsUnicastConforming | Counter64, |
| ethResCOSOutDiscardsOctetsUnicastNonConforming | Counter64, |
| ethResCOSOutDiscardsOctetsMulticast | Counter64, |
| ethResCOSOutDiscardsOctetsMulticastConforming | Counter64, |
| ethResCOSOutDiscardsOctetsMulticastNonConforming | Counter64, |
| ethResCOSOutDiscardsOctetsBroadcast | Counter64, |
| ethResCOSOutDiscardsOctetsBroadcastConforming | Counter64, |
| ethResCOSOutDiscardsOctetsBroadcastNonConforming | Counter64, |
| } | |
| ifIndex OBJECT-TYPE | |

| | |
|---|---|
| SYNTAX | InterfaceIndex |
| MAX-ACCESS | read-only |
| STATUS | current |
| DESCRIPTION | |

“A unique value, greater than zero, for each interface. It is
recommended that values are assigned contiguously starting from
1. The value for each interface must remain constant at least
from one re-initialization of the entity's network management
system to the next re-initialization.”

::= { ethResEntry 1 }
ethResIndex OBJECT-TYPE

| | |
|---|---|
| SYNTAX | EthResIndex |
| MAX-ACCESS | read-only |
| STATUS | current |
| DESCRIPTION | |

“A unique value, greater than zero, that represents a Service
or Trunk. An ethResIndex can be a VLAN or any other identifier
that refers to a service or trunk. If the value is zero it
indicates a service or trunk is not present and the MIB is
addressing the interface.”

::= { ethResEntry 2 }
classOfEthResIndex OBJECT-TYPE

| | |
|---|---|
| SYNTAX | INTEGER { |
| | Standard(0), |
| | Bronze(1), |
| | Silver(2), |
| | Gold(3), |
| | Platinum(4), |
| | Premium(5), |
| | Network(6), |
| | Critical(7) |
| | } |

| | |
|---|---|
| MAX-ACCESS | read-only |
| STATUS | current |
| DESCRIPTION | |

“A unique value between 0-7, that represents a Class of
Service. An ethResIndex can be a VLAN or any other identifier
that refers to a service or trunk. If the value is zero it
indicates a service or trunk is not present and the MIB is
addressing the interface.”

::= { EthResCOSEntry 3 }

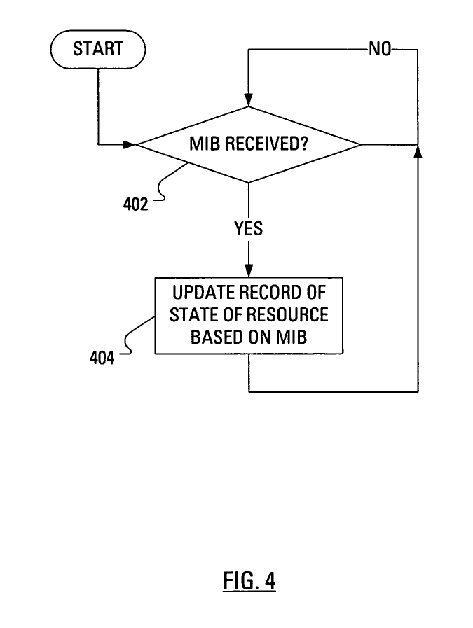

In view of FIG. 4, the management console 118 determines (step 402) whether a message has been received. As discussed hereinbefore, the message may take the form of or include a MIB as proposed above. Upon determining that no MIB has been received, the management console 118 continues to await receipt of a MIB. Upon determining that a MIB has been received, the management console 118 updates (step 404) a record of the state of the resource to which the MIB pertains based on the content of the MIB.

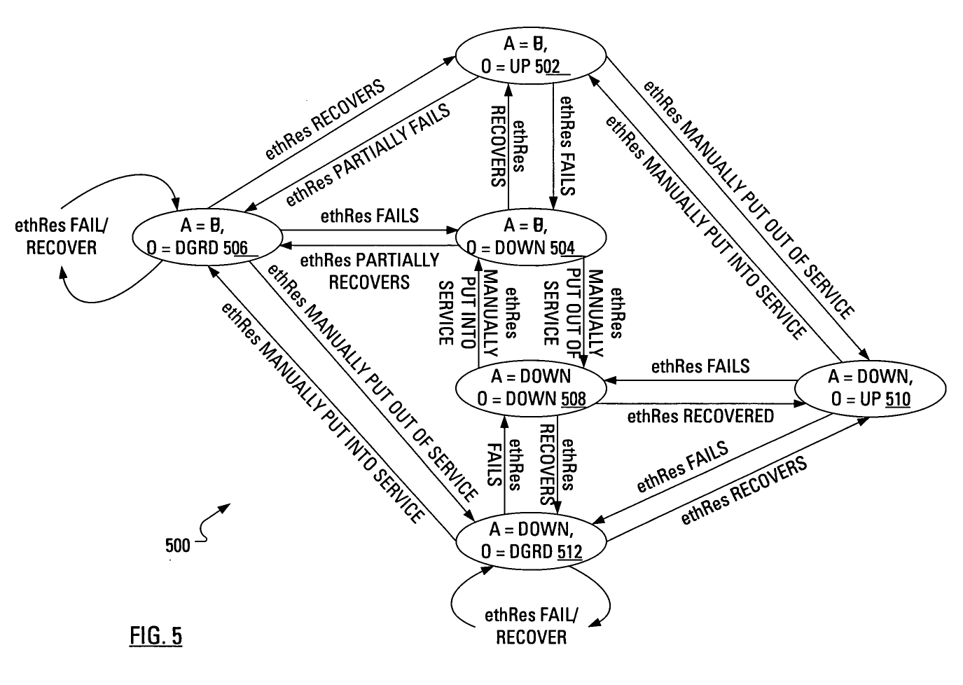

A number of states may be defined for the various resources (links, trunks, services) of the Ethernet Resource 102. The defined states and an indication of a relationship between the states may be found in a state diagram 500 in FIG. 5. Each state is defined by an administrative state and an operational state. The administrative state is represented, in FIG. 5, by the character “A” and, in the above-proposed MIB, by the element “ethResAdminStatus”. The operational state is represented, in FIG. 5, by the character “O” and, in the above-proposed MIB, by the element “ethResOperStatus”.

In an “A=UP, O=UP” state 502, all resources of the Ethernet Resource 102 are administratively in service and available, i.e., each link, trunk and service are capable of carrying traffic.

In an “A=UP, O=DEGRADED” state 506, the Ethernet Resource 102 is administratively in service but some resources are not capable of carrying traffic. In other words, one or more, but not all, resources within the Ethernet Resource 102 are out of service. The out of service state of a resource can be detected by the management agent 107 at one of the nodes 106 having a related end point, through the use of the ITU-T Y.1731 and IEEE 802.1ag protocols, and then reported to one or more of the management consoles 118, 120 using, for example, an instance of the ethResEntry object formatted according to the above-proposed MIB.

In an “A=UP, O=DOWN” state 504, the Ethernet Resource 102 is administratively in service, but none of the resources of the Ethernet Resource 102 are capable of carrying traffic. In other words, all resources of the Ethernet Resource 102 are out of service. One of the management consoles 118, 120 may detect that all resources of the Ethernet Resource 102 are out of service through the receipt of many instances of the ethResEntry object formatted according to the above-proposed MIB.

In an “A=DOWN, O=UP” state 510, the Ethernet Resource 102 is administratively out of service and all links among the nodes 106 are capable of carrying traffic. In other words, all resources of the Ethernet Resource 102 are in service, but the Ethernet Resource 102 is administratively out of service.

In an “A=DOWN, O=DEGRADED” state 512, the Ethernet Resource 102 is administratively out of service, but only some resources of the Ethernet Resource 102 are not capable of carrying traffic. In other words, one or more resources of the Ethernet Resource 102 are out of service. As stated hereinbefore, the out of service state of a resource can be detected by one of the nodes 106 having a related end point through the use of the ITU-T Y.1731 and IEEE 802.1ag protocols.

Finally, in an “A=DOWN, O=DOWN” state 508, the Ethernet Resource 102 is administratively out of service and all resources within the Ethernet Resource 102 are not capable of carrying traffic. In other words, all resources within the Ethernet Resource 102 are out of service.

It should be clear from the above description in conjunction with the state diagram 500 illustrated in FIG. 5, that an Ethernet Resource 102 in the “A=UP, O=UP” state 502 can be considered to have moved into the “A=UP, O=DOWN” state 504 upon detection of a failure of all resources of the Ethernet Resource 102. Correspondingly, an Ethernet Resource 102 in the “A=UP, O=DOWN” state 504 can be considered to have moved into the “A=UP, O=UP” state 502 upon detection of a recovery of all failed resources of the Ethernet Resource 102.

Upon detection that at least one resource of the Ethernet Resource 102, but not all resources, has failed, an Ethernet Resource 102 in the “A=UP, O=UP” state 502 can be considered to have moved into the “A=UP, O=DEGRADED” state 506. Correspondingly, an Ethernet Resource 102 in the “A=UP, O=DEGRADED” state 506 can be considered to have moved into the “A=UP, O=UP” state 502 upon detection of a recovery of all failed resources of the Ethernet Resource 102.

Upon detection of an Ethernet Resource 102 in the “A=UP, O=UP” state 502 being manually put out of service, the Ethernet Resource 102 can be considered to have moved into the “A=DOWN, O=UP” state 510. Correspondingly, upon detection of an Ethernet Resource 102 in the “A=DOWN, O=UP” state 510 being manually put into service, the Ethernet Resource 102 can be considered to have moved into the “A=UP, O=UP” state 502.

Upon detection of a recovery of at least one, but not all, of the failed resources of the Ethernet Resource 102, an Ethernet Resource 102 in the “A=UP, O=DOWN” state 504 can be considered to have moved into the “A=UP, O=DEGRADED” state 506. Correspondingly, upon detection of the failure of the remaining operational resources, an Ethernet Resource 102 in the “A=UP, O=DEGRADED” state 506 can be considered to have moved into the “A=UP, O=DOWN” state 504.

Upon detection of an Ethernet Resource 102 in the “A=UP, O=DOWN” state 504 being manually put out of service, the Ethernet Resource 102 can be considered to have moved into the “A=DOWN, O=DOWN” state 508. Correspondingly, upon detection of an Ethernet Resource 102 in the “A=DOWN, O=DOWN” state 508 being manually put into service, the Ethernet Resource 102 can be considered to have moved into the “A=UP, O=DOWN” state 504.

Upon detection of a recovery of at least one, but not all, of the failed resources, an Ethernet Resource 102 in the “A=DOWN, O=DOWN” state 508 can be considered to have moved into the “A=DOWN, O=DEGRADED” state 512. Correspondingly, upon detection of the failure of the remaining operational resources, an Ethernet Resource 102 in the “A=DOWN, O=DEGRADED” state 512 can be considered to have moved into the “A=DOWN, O=DOWN” state 508.

Upon detection of a recovery of all of the failed resources, an Ethernet Resource 102 in the “A=DOWN, O=DEGRADED” state 512 can be considered to have moved into the “A=DOWN, O=UP” state 510. Correspondingly, upon detection of the failure of at least one, but not all resources, an Ethernet Resource 102 in the “A=DOWN, O=UP” state 510 can be considered to have moved into the “A=DOWN, O=DEGRADED” state 512.

Upon detection of a failure of all of the resources, an Ethernet Resource 102 in the “A=DOWN, O=UP” state 510 can be considered to have moved into the “A=DOWN, O=DOWN” state 508. Correspondingly, upon detection of the recovery of all of the resources, an Ethernet Resource 102 in the “A=DOWN, O=DOWN” state 508 can be considered to have moved into the “A=DOWN, O=UP” state 510.

Upon detection of an Ethernet Resource 102 in the “A=UP, O=DEGRADED” state 506 being manually put out of service, the Ethernet Resource 102 can be considered to have moved into the “A=DOWN, O=DEGRADED” state 512. Correspondingly, upon detection of an Ethernet Resource 102 in the “A=DOWN, O=DEGRADED” state 512 being manually put into service, the Ethernet Resource 102 can be considered to have moved into the “A=UP, O=DEGRADED” state 506.

Upon detection, by an Ethernet Resource 102 in the “A=UP, O=DEGRADED” state 506, of the failure of another resource and provided that the failed resource was not the last operational resource, the Ethernet Resource 102 remains in the “A=UP, O=DEGRADED” state 506.

Similarly, upon detection, by an Ethernet Resource 102 in the “A=DOWN, O=DEGRADED” state 512, of the failure of another resource and provided that the failed resource was not the last operational resource, the Ethernet Resource 102 remains in the “A=DOWN, O=DEGRADED” state 512.

In overview, the state of the Ethernet Resource 102 can be monitored and maintained at the EMS 108 as the management console 118 associated with the EMS 108 receives updated MIBs from the management agents 107 at the nodes 106 within the Ethernet Resource 102.

In a first scenario, traffic for the service resource provided by the Ethernet Resource 102 is routed between the first node 106A and the fourth node 106D over the second trunk, via the third node 106C. The first link becomes operationally down due to a failure. The management agent 107A at the first node 106A detects the failure of the first link at end point L1 and transmits a MIB with the following content to the management console 118 at the EMS 108:

ifIndex = L1
ethResIndex = 0
ethResType = 0
ethResAdminStatus = up
serviceOperStatus = down.

Similarly, the management agent 107B at the second node 106B detects the failure of the first link at end point L2 and transmits a MIB with the following content to the management console 118:

ifIndex = L2
ethResIndex = 0
ethResType = 0
ethResAdminStatus = up
serviceOperStatus = down.

Additionally, the management agent 107A at the first node 106A detects the failure of the first trunk at end point T1 and transmits a MIB with the following content to the management console 118:

ifIndex = L1
ethResIndex = T1
ethResType = 2
ethResAdminStatus = up
serviceOperStatus = down.

Similarly, the management agent 107D at the fourth node 106D detects the failure of the first trunk at end point T1 and transmits a MIB with the following content to the management console 118:

ifIndex = L4
ethResIndex = T1
ethResType = 2
ethResAdminStatus = up
serviceOperStatus = down.

Notably, since the service resource is not routed over the first trunk, which includes the failed first link, the service resource remains operationally up and no new MIBs are transmitted related to the service resource. Accordingly, the state, maintained at the management console 118, of the first link is set to “A=UP, O=DOWN” state 504 and the state of the first trunk is set to “A=UP, O=DOWN” state 504. However, the service resource remains in the “A=UP, O=UP” state 502.

In a second scenario, traffic for the service resource provided by the Ethernet Resource 102 is routed between the first node 106A and the fourth node 106D over the second trunk, via the third node 106C. The first trunk becomes administratively down due to instructions received by the management agents 107 at the first node 106A, the second node 106B and the fourth node 106D. The management agent 107A at the first node 106A detects the administrative down status of the first trunk at end point T1 and transmits a MIB with the following content to the management console 118 at the EMS 108:

ifIndex = L1
ethResIndex = T1
ethResType = 2
ethResAdminStatus = down
serviceOperStatus = up.

Similarly, the management agent 107D at the fourth node 106D detects the administrative down status of the first trunk at end point T1 and transmits a MIB with the following content to the management console 118:

ifIndex = L4
ethResIndex = T1
ethResType = 2
ethResAdminStatus = up
serviceOperStatus = down.

Again, since the service resource is not routed over the first trunk, which has been administratively taken down, the service resource remains operationally up and no new MIBs are transmitted related to the service resource. Accordingly, the state, maintained at the management console 118, of the first trunk is set to the “A=DOWN, O=UP” state 510. Meanwhile, all four links, the second trunk and the service resource remain in the “A=UP, O=UP” state 502.

In a third scenario, the service resource becomes administratively down due to instructions received by the management agent 107A at the first node 106A. The management agent 107A at the first node 106A detects the administrative down status of the service resource at end point S1 and transmits a MIB with the following content to the management console 118 at the EMS 108:

ifIndex = L9
ethResIndex = S1
ethResType = 1
ethResAdminStatus = down
serviceOperStatus = up.

Additionally, the management agent 107D at the fourth node 106D detects the administrative down status of the service resource at end point S1 and transmits a MIB with the following content to the management console 118:

ifIndex = L10
ethResIndex = S1
ethResType = 1
ethResAdminStatus = down
serviceOperStatus = up.

Accordingly, the state, maintained at the management console 118, of the service resource is set to the “A=DOWN, O=UP” state 510. Meanwhile, all four links and both trunks remain in the “A=UP, O=UP” state 502.

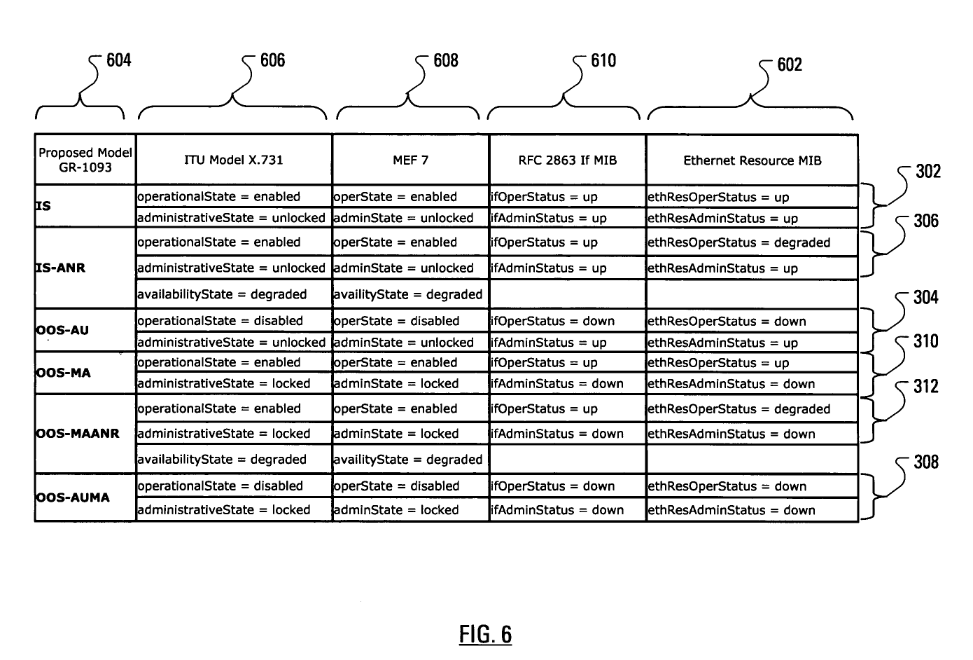

FIG. 6 illustrates a state table 600 providing a convenient manner in which to compare the states proposed for the state diagram 500 with the states available in other technologies. In particular, the states proposed herein are in a column of the state table 600 identified by the reference numeral 602. The states proposed in “GR-1093, Generic State Requirements for Network Elements”, Issue 2, Telcordia, 2000 (see telecom-info.telcordia.com) are in a column of the state table 600 identified by the reference numeral 604. The states proposed in “Information technology—Open Systems Interconnection—Systems management: State management function”, Recommendation X.731, ITU, January, 1992 (see www.itu.int/rec/T-REC-X.731-199201-I/en) are in a column of the state table 600 identified by the reference numeral 606. The states proposed in “Technical Specification—MEF 7—EMS-NMS Information Model”, Metro Ethernet Forum, October 2004 (see metroethernetforum.org) are in a column of the state table 600 identified by the reference numeral 608. The states proposed in “Request for Comments (RFC) 2863—The Interface Group MIB”, Internet Engineering task Force, June 2000 (see www.ietf.org) are in a column of the state table 600 identified by the reference numeral 610.

Conveniently, the solution described hereinbefore offers separate MIBs: service resource-specific MIBs; trunk resource-specific MIBs; and link resource-specific MIBs. The separate, resource-specific MIBs stand in contrast to current Internet Protocol and Ethernet solutions, which offer port-based MIBs.

An Ethernet packet switched network infrastructure with link, trunk and service layers that offer operational features to help providers administer their networks is of great value. Network providers that have plans for packet infrastructure and may require operational solutions that have some, if not all, of the existing operational features of known SONET/SDH/ATM systems.

A framework, Ethernet Resource structure and objects have been presented above for the management of link, trunk and service resources. Such a framework may find application in a Metro Area network or other Wide Area Network. Furthermore, the framework may be extended in a Local Area Network (LAN) for management of critical infrastructure LAN Networks. As Ethernet technology evolves, Ethernet Resources are expected to require deployment features and operational states to enable the management and operations of both Ethernet infrastructure and service networking. Operational states may be useful for effective Ethernet resource management and billing. According to the foregoing, common Ethernet resource management at many layers is facilitated by the definition of a common operational state model for each resource at each level. Both private critical network infrastructure (enterprise, manufacturing, industrial, utility) and Service Provider (Network Service Provider, Internet Service Provider or Application Service Provider) can all benefit from Ethernet resources management and operation states that deliver predictable networking and flexibility for moves, adds and changes of both service and network resources.

The systems and methods of the foregoing may enable new Ethernet resource management for 802.1 and 802.3 resources and allow OAM features and functions in new PB/PBB/PBT wireline, wireless and fiber optic networks. The features and functions may be seen to correlate to OAM features and functions in existing SONET/SDH/ATM circuit solutions.

The above-described embodiments of the present application are intended to be examples only. Alterations, modifications and variations may be effected to the particular embodiments by those skilled in the art without departing from the scope of the application, which is defined by the claims appended hereto.

What is claimed is:

1. A method of maintaining a record of a state of a resource within an Ethernet Resource, said Ethernet Resource including a plurality of nodes connected by a plurality of links, said method comprising:
receiving a message from a given node among said plurality of nodes, said message having content including:
a reference to a given resource;
an indication of an administrative state of said given resource, where said administrative state is selected from an administrative up state and an administrative down state; and
an indication of an operational state of said given resource, where said operational state is selected from an operational up state, an operational degraded state and an operational down state; and
based on said content, updating said record of said state of said resource to a new state.

2. The method of claim 1 wherein said resource is a link resource.

3. The method of claim 1 wherein said resource is a trunk resource.

4. The method of claim 1 wherein said resource is a service resource.

5. The method of claim 1 wherein said new state is administratively up and operationally up.

6. The method of claim 1 wherein said new state is administratively up and operationally down.

7. The method of claim 1 wherein said new state is administratively up and operationally degraded.

8. The method of claim 1 wherein said new state is administratively down and operationally down.

9. The method of claim 1 wherein said new state is administratively down and operationally up.

10. The method of claim 1 wherein said new state is administratively down and operationally degraded.

11. A system for managing an Ethernet Resource having a plurality of resources, said system comprising a management console adapted to:
receive a message from a given node among said plurality of nodes, said message having content including:
a reference to a given resource;
an indication of an administrative state of said given resource, where said administrative state is selected from an administrative up state and an administrative down state; and
an indication of an operational state of said given resource, where said operational state is selected from an operational up state, an operational degraded state and an operational down state; and
based on said content, update said record of said state of said resource to a new state.

12. A computer readable medium containing computer-executable instructions that, when performed by a processor, cause said processor to:
receive a message from a given node among a plurality of nodes, said message having content including:
a reference to a given resource;
an indication of an administrative state of said given resource, where said administrative state is selected from an administrative up state and an administrative down state; and
an indication of an operational state of said given resource, where said operational state is selected from an operational up state, an operational degraded state and an operational down state; and
based on said content, update a record of a state of said resource to a new state.

13. A method of facilitating management of a state of a resource within an Ethernet Resource, said Ethernet Resource including a plurality of nodes connected by a plurality of links, said method comprising:
detecting a change in state of a given resource; and transmitting a message to a management system, said message identifying said given resource, an operational state of said given resource and an administrative state of said resource.

14. The method of claim 13 wherein an interface is associated with said given resource and said message further identifies said interface.

15. The method of claim 13 wherein said message further identifies a type for said resource.

16. The method of claim 15 wherein said type of said resource is link.

17. The method of claim 15 wherein said type of said resource is trunk.

18. The method of claim 15 wherein said type of said resource is service.

19. The method of claim 13 wherein said message is a Management Information Base.

20. The method of claim 13 wherein said administrative state is selected from an administrative up state and an administrative down state and said operational state is selected from an operational up state, an operational degraded state and an operational down state.

21. A node in an Ethernet Resource, said node associated with resources, said node including a management agent arranged to:
detect a change in state of a given resource; and
transmit a message to a management system, said message identifying said given resource, an operational state of said given resource and an administrative state of said resource.

22. A computer readable medium containing computer-executable instructions that, when performed by a processor, cause said processor to:
detect a change in state of a given resource; and
transmit a message to a management system, said message identifying said given resource, an operational state of said given resource and an administrative state of said resource.

23. A computer readable medium storing a Management Information Base (MIB) to support an Operation, Administration and Maintenance structure for an Ethernet Resource, said MIB comprising:
a reference to a given resource;
an indication of an administrative state of said given resource, where said administrative state is selected from an administrative up state and an administrative down state; and
an indication of an operational state of said given resource, where said operational state is selected from an operational up state, an operational degraded state and an operational down state.

24. The computer readable medium of claim 23 wherein said MIB further comprises an indication of a type for said given resource.

25. The computer readable medium of claim 23 wherein said MIB further comprises an indication of an interface associated with said given resource.

26. The computer readable medium of claim 23 wherein said given resource is a link resource.

27. The computer readable medium of claim 23 wherein said given resource is a trunk resource.

28. The computer readable medium of claim 23 wherein said given resource is a service resource.
